(19) United States
(12) Patent Application Publication
(10) Pub. No.: US 2020/0398928 A1
(43) Pub. Date: Dec. 24, 2020

(54) THROTTLE ASSISTANCE DEVICE FOR MOTORCYCLE HANDLE GRIP AND MOTORCYCLE HANDLE GRIP ASSEMBLY WITH THE SAME

(71) Applicant: Billy HO, Taipei City (TW)

(72) Inventor: Billy HO, Taipei City (TW)

(21) Appl. No.: 16/450,887

(22) Filed: Jun. 24, 2019

(51) Int. Cl. B62K 23/04

(52) U.S. Cl. CPC B62K 23/04

(57) ABSTRACT

A throttle assistance device for a motorcycle handle grip has a grip fixing element and a hand press panel. The grip fixing element is mounted securely on the motorcycle handle grip. The hand press panel is pivotally connected to the grip fixing element, so that the hand press panel can be pressed by an outer side of a palm of the rider to assist in rotating the motorcycle handle grip when in use. When the hand press panel is temporarily not in use, the rider only needs to push to pivot the hand press panel toward an outer end of the motorcycle handle grip, and then the hand press panel will become upright or substantially upright, thereby preventing the hand press panel from occupying too much holding space on the motorcycle handle grip. Thus, the throttle assistance device facilitates ease in use and ensures riding safety.

### BACKGROUND

### 1. Field

The present disclosure relates to a throttle assistance device for a motorcycle handle grip, especially to a throttle assistance device that facilitates rotation of the motorcycle handle grip by a rider.

### 2. Description of the Prior Arts

The throttle of a conventional motorcycle is controlled by rotating the handle grip. During a long-distance ride, the rider needs to hold tightly and rotate the motorcycle handle grip with his fingers for a long time, which will result in discomfort of the fingers. Thus, a throttle assistance device for the motorcycle handle grip is developed to facilitate rotating the handle grip and reducing the fingers' burden.

With reference to FIGS. 9 and 10, a throttle assistance device 92 is mounted securely around a motorcycle handle grip 91, so that the throttle assistance device 92 can rotate the motorcycle handle grip 91. To be specific, the throttle assistance device 92 has a hand press panel 921 allowing the rider to press by an outer side of his palm. Therefore, the rider can press his hand to assist in rotating the motorcycle handle grip 91, thereby reducing the burden of the fingers.

However, the above-mentioned throttle assistance device 92 has the following shortcomings:

First, the throttle assistance device 92 still occupies some space when not in use. For example, when stopping to wait for a red light to switch, the rider has to release the throttle. During this wait time, he does not need to press the hand press panel 921, but the hand press panel 921 is still there and occupies the holding space on the motorcycle handle grip 91, which is inconvenient and may further affect riding safety.

Second, the conventional throttle assistance device 92 is mounted securely on the motorcycle handle grip 91 via a sheet 922 surrounding the motorcycle handle grip 91. But this means of connection is apparently not stable enough, and thus cannot prevent the throttle assistance device 92 from sliding and rotating relative to the motorcycle handle grip 91. Particularly, during each ride, the rider has to press the hand press panel 921 very frequently to rotate the motorcycle handle grip 91. Under frequent use, the unstable connection between the throttle assistance device 92 and the motorcycle handle grip 91 further results easily in slip and relative rotation of the throttle assistance device 92 to the motorcycle handle grip 91, which not only reduces the lifespan, but also affects riding safety.

### SUMMARY

To overcome the shortcomings, various embodiments of the present disclosure provide a throttle assistance device for a motorcycle handle grip and a motorcycle handle grip assembly with the same to mitigate or obviate at least the aforementioned problems.

In some embodiments, provided herein are a throttle assistance device for a motorcycle handle grip and a motorcycle handle grip assembly with the same that can be pushed to pivot a hand press panel into a folded condition when not in use to avoid occupying too much holding space.

The throttle assistance device is for a motorcycle handle grip. The motorcycle handle grip is rotatably mounted around a handlebar. The motorcycle handle grip has an inner end and an outer end. The throttle assistance device includes a grip fixing element and a hand press panel. The grip fixing element is adapted to be mounted securely on the motorcycle handle grip. The hand press panel is pivotally connected to the grip fixing element and is pivotable relative to the grip fixing element into an in-use condition and a folded condition. When the hand press panel is in the in-use condition, the hand press panel in the in-use condition is pivotable toward the outer end of the motorcycle handle grip to transfer into the folded condition.

The motorcycle handle grip assembly is adapted to be mounted around a handlebar of a motorcycle. The motorcycle handle grip includes a motorcycle handle grip and a hand press panel. The motorcycle handle grip is rotatably mounted around the handlebar, and has an inner end and an outer end. The hand press panel is pivotally connected to the motorcycle handle grip and is pivotable relative to the motorcycle handle grip into an in-use condition and a folded condition. When the hand press panel is in the in-use condition, the hand press panel in the in-use condition is pivotable toward the outer end of the motorcycle handle grip to transfer into the folded condition.

In some embodiments, advantages may be provided as follows. The hand press panel is pivotally connected to the grip fixing element or the motorcycle handle grip, so that the hand press panel can be pressed by an outer side of a palm of the rider to assist in rotating the motorcycle handle grip when in use. When the hand press panel is temporarily not in use, the rider only needs to push to pivot the hand press panel toward the outer end of the motorcycle handle grip, and then the hand press panel will become upright or substantially upright, thereby preventing the hand press panel from occupying too much holding space on the motorcycle handle grip. Thus, the throttle assistance devices not only facilitates ease in use, but also ensures riding safety.

Other objectives, advantages and novel features of the present disclosure will become more apparent from the following detailed description when taken in conjunction with the accompanying drawings.

### BRIEF DESCRIPTION OF THE DRAWINGS

FIG. 1 is a perspective view of a throttle assistance device for a motorcycle handle grip in accordance with one or more embodiments of the present disclosure, shown in an in-use condition;

FIG. 2 is a perspective view of the throttle assistance device of FIG. 1, shown in a folded condition;

FIG. 3 is an exploded perspective view of the throttle assistance device of FIG. 1;

FIG. 4 is a top view of the throttle assistance device of FIG. 1 mounted around the motorcycle handle grip, shown in the in-use condition;

FIG. 5 is a top view of the throttle assistance device of FIG. 1 mounted around the motorcycle handle grip, shown in the folded condition;

FIG. 6 is a side view in partial section of the throttle assistance device of FIG. 1 mounted around the motorcycle handle grip;

FIG. 7 is a top view of a motorcycle handle grip assembly in accordance with one or more embodiments of the present disclosure mounted on a motorcycle, shown in the folded condition;

FIG. 8 is a side view in partial section of the motorcycle handle grip assembly of FIG. 7 mounted on the motorcycle;

FIG. 9 is a top view of a throttle assistance device in accordance with the prior art mounted around a motorcycle handle grip; and

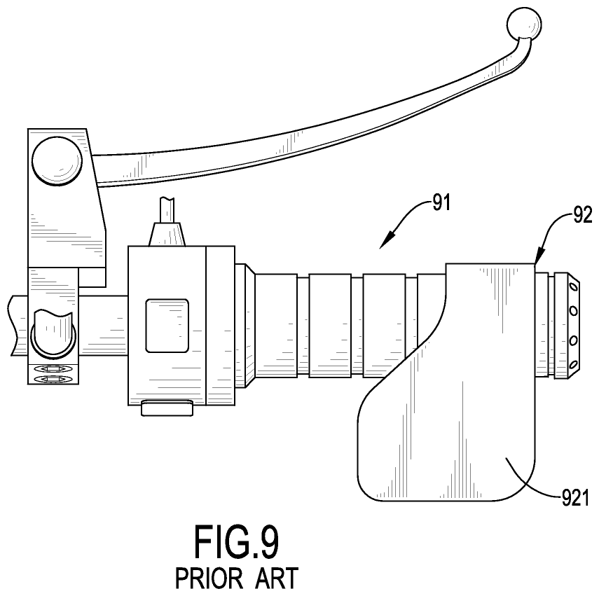

FIG. 10 is a side view in partial section of the throttle assistance device of FIG. 9 mounted around the motorcycle handle grip.

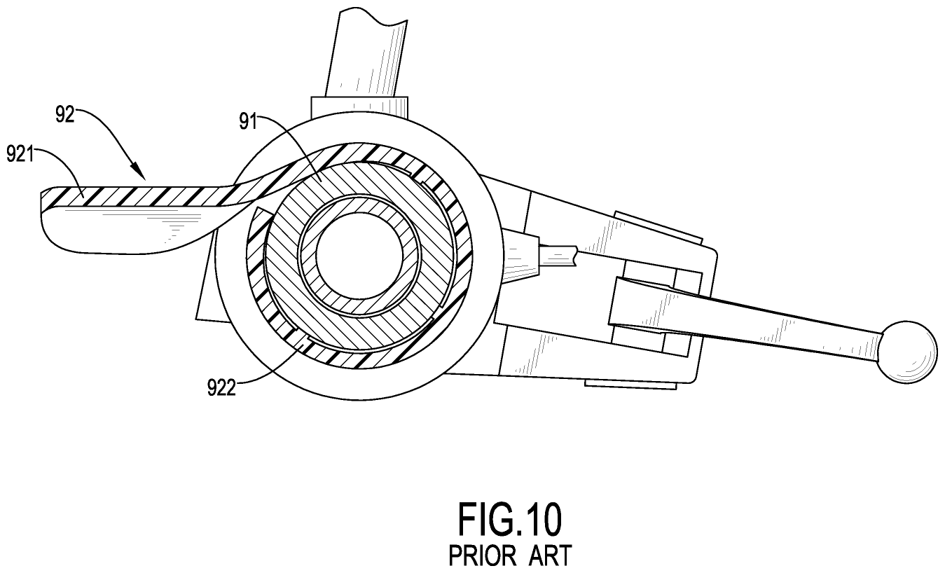

### DETAILED DESCRIPTION OF THE PREFERRED EMBODIMENTS

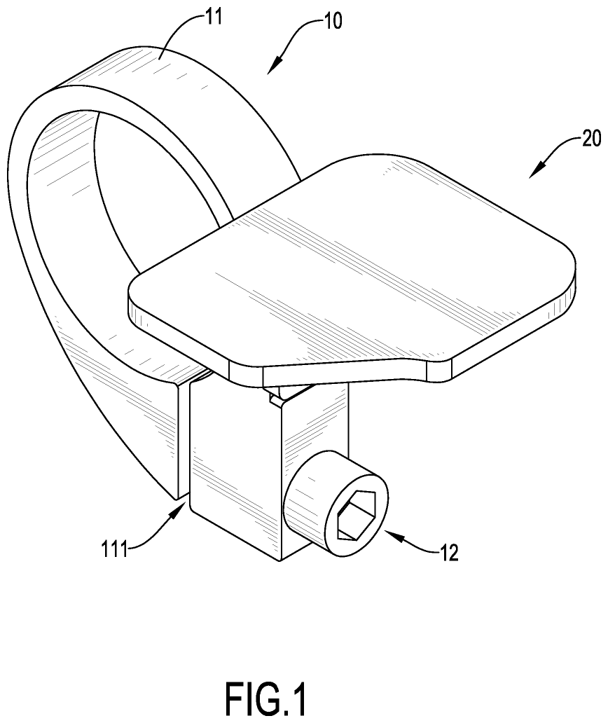

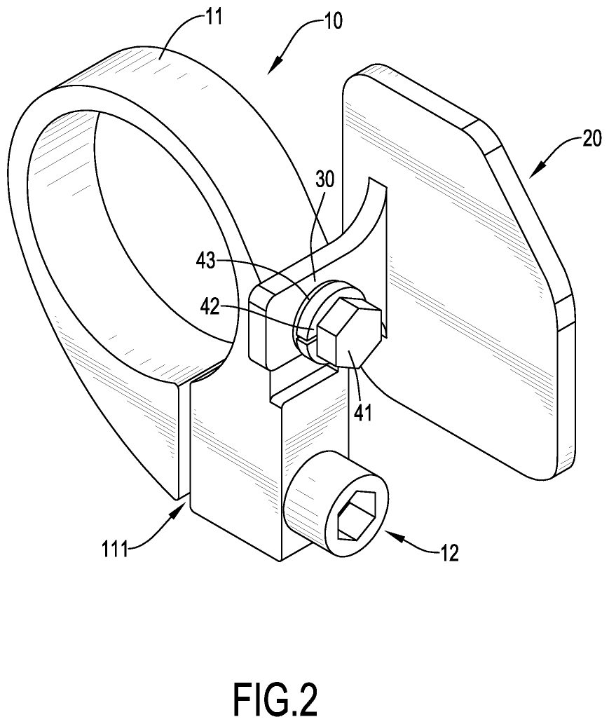

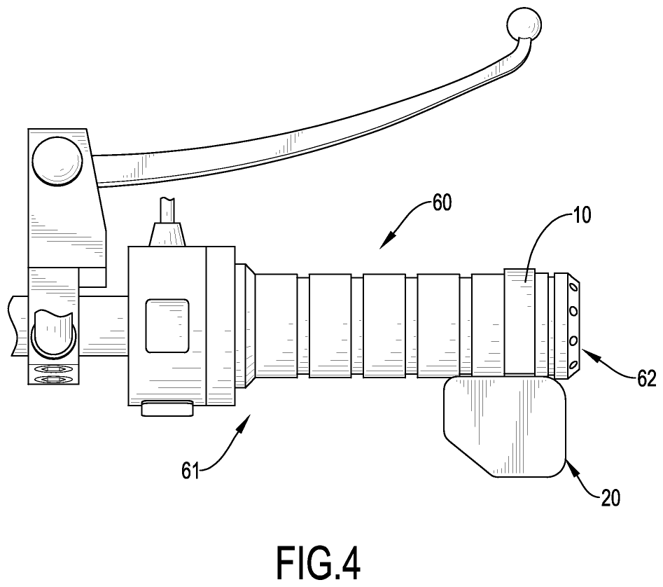

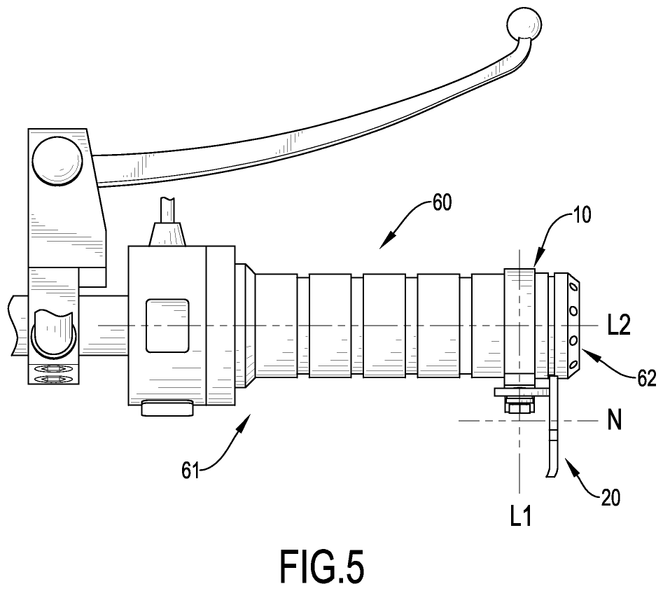

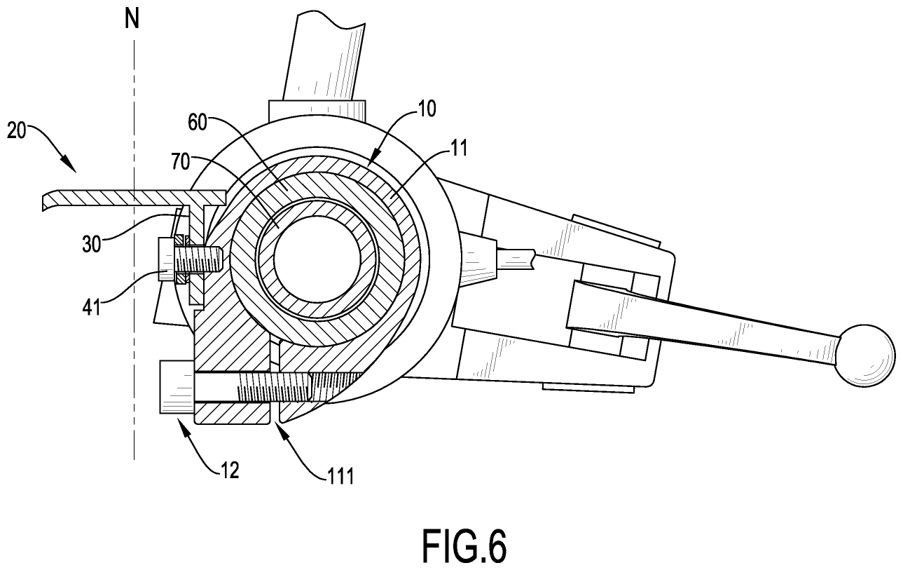

With reference to FIGS. 1, 2, and 6, an throttle assistance device (also referred to as a motorcycle handle grip assistance device) in accordance with one or more embodiments of the present disclosure is rotatably mounted around a motorcycle handle grip 60, and the motorcycle handle grip 60 is rotatably mounted around a handlebar 70. The motorcycle handle grip 60 has an inner end 61 and an outer end 62, as denoted in FIGS. 4 and 5. The inner end 61 is closer to a center line of a motorcycle relative to the outer end 62. The motorcycle handle grip assistance device includes a grip fixing element 10 and a hand press panel 20.

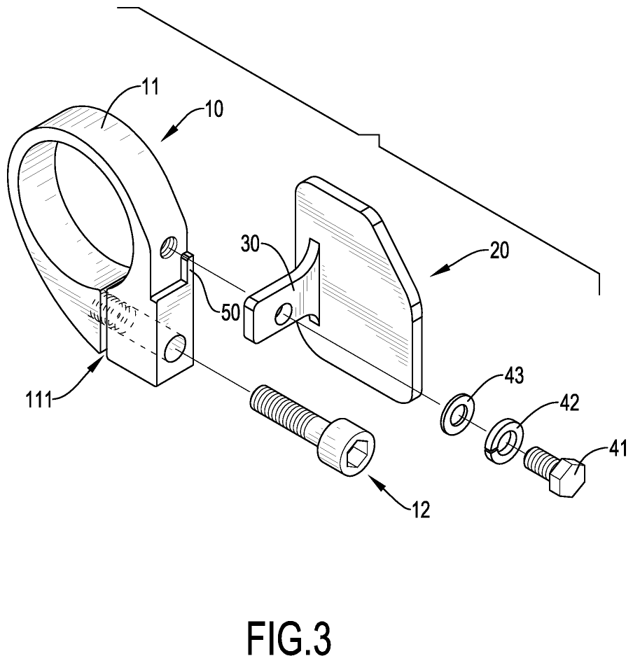

With reference to FIGS. 3, 5, and 6, the grip fixing element 10 is adapted to be mounted securely on the motorcycle handle grip 60. In a preferred embodiment, the grip fixing element 10 includes a surrounding frame 11 and a fixing screw 12. The surrounding frame 11 is adapted to surround and abut the motorcycle handle grip 60, and the surrounding frame 11 has a gap 111 formed therethrough to cut and divide the surrounding frame 11 to form two ends on the surrounding frame 11. The fixing screw 12 is mounted through one of the two ends of the surrounding frame 11, and is screwed in the other end of the surrounding frame 11. In some cases, the fixing screw 12 can shorten a distance between the two ends of the surrounding frame 11, which can allow the surrounding frame 11 to tightly surround and abut the motorcycle handle grip 60. Therefore, the motorcycle handle grip assistance device of the present disclosure can stably rotate the motorcycle handle grip 60 and avoid slip and relative rotation between the throttle assistance device and the motorcycle handle grip 60. However, the structure of the grip fixing element 10 is not limited to the above-mentioned. The structure of the grip fixing element 10 may be altered as long as the grip fixing element 10 can be mounted securely on the motorcycle handle grip 60.

The hand press panel 20 is pivotally connected to the grip fixing element 10. In a preferred embodiment, the hand press panel 20 is pivotally connected to the grip fixing element 10 via a connecting element 30 and a pivot screw 41. An end of the connecting element 30 is connected to an inner side surface of the hand press panel 20. Further, the connecting element 30 and the hand press panel 20 are preferably formed integrally, which means the connecting element 30 and the hand press panel 20 are two portions of an integral article rather than two separate articles combined together, but it is not limited thereto. The pivot screw 41 is mounted through the connecting element 30, and then is screwed in the grip fixing element 10. A head of the pivot screw 41 can prevent the connecting element 30 and the grip fixing element 10 from separating from each other. The head of the pivot screw 41 does not tightly abut the connecting element 30, such that the connecting element 30 and the hand press panel 20 are still rotatable relative to the grip fixing element 10. In addition, in a preferred embodiment, a washer 42 and a gasket 43 are mounted around the pivot screw 41, thereby reducing the friction between the connecting element 30 and the pivot screw 41. The rotational structure between the hand press panel 20 and the grip fixing element 10 is not limited to a screw, and may be altered into a tenon or magnet, as long as the hand press panel 20 can be pivotally connected to the grip fixing element 10.

The hand press panel 20 is pivotable, relative to the grip fixing element 10, into an in-use condition and a folded condition. In the in-use condition, the hand press panel 20 is pivoted to be pressable by an outer side of a palm of the rider to assist in rotating the motorcycle handle grip 60. When the rider does not need to press the hand press panel 20, the hand press panel 20 can be pivoted into the folded condition, which is a condition that occupies less space on the motorcycle handle grip 60, and the outer side of the palm of the rider may not contact the hand press panel 20. To transfer the hand press panel 20 from the in-use condition into the folded condition, the hand press panel 20 in the in-use condition is pivoted toward the outer end 62 of the motorcycle handle grip 60. To transfer the hand press panel 20 from the folded condition to the in-use condition, the hand press panel 20 in the folded condition is pivoted toward the inner end 61 of the motorcycle handle grip 60.

With reference to FIGS. 4 to 6, in a preferred embodiment, a pivoting axis L1 between the hand press panel 20 and the grip fixing element 10 is perpendicular to a rotating axis L2 between the motorcycle handle grip 60 and the handlebar 70 as shown in FIG. 5. Preferably, when the hand press panel 20 is in the in-use condition, a normal N of the hand press panel 20 is perpendicular to the rotating axis L2 of the motorcycle handle grip 60 and the handlebar 70. When the hand press panel 20 is in the folded condition, the normal N of the hand press panel 20 is parallel with the rotating axis L2 between the motorcycle handle grip 60 and the handlebar 70 as shown in FIG. 5. The pivot angles are not limited to the above-mentioned. An angle between the pivoting axis L1 (between the hand press panel 20 and the grip fixing element 10) and the rotating axis L2 (between the motorcycle handle grip 60 and the handlebar 70) also can be larger or smaller than 90 degrees. In the in-use condition and in the folded condition, an angle between the normal N of the hand press panel 20 and the rotating axis L2 (between the motorcycle handle grip 60 and the handlebar 70) also can be in other degrees, as long as the hand press panel 20 does not occupy too much holding space on the motorcycle handle grip 60 after the hand press panel 20 is pivoted toward the outer end 62.

With reference to FIG. 3, in a preferred embodiment, the throttle assistance device further includes a limiting element 50, which is mounted on the grip fixing element 10. The limiting element 50 and the grip fixing element 10 are preferably formed integrally, which means the limiting element 50 and the grip fixing element 10 are two portions of an integral article rather than two separate articles combined together, but it is not limited thereto. The limiting element 50 selectively abuts the connecting element 30. To be specific, when the hand press panel 20 is pivoted until the connecting element 30 abuts the limiting element 50, it means the hand press panel 20 has been pivoted into the folded condition. Besides, in another embodiment wherein the hand press panel 20 is implemented without the connecting element 30, the hand press panel 20 itself abuts the limiting element 50 during the pivoting, which also means the hand press panel 20 has been pivoted into the folded condition.

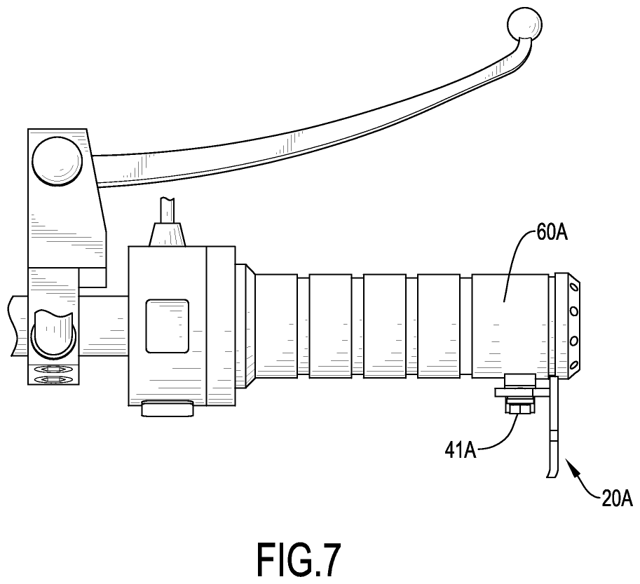

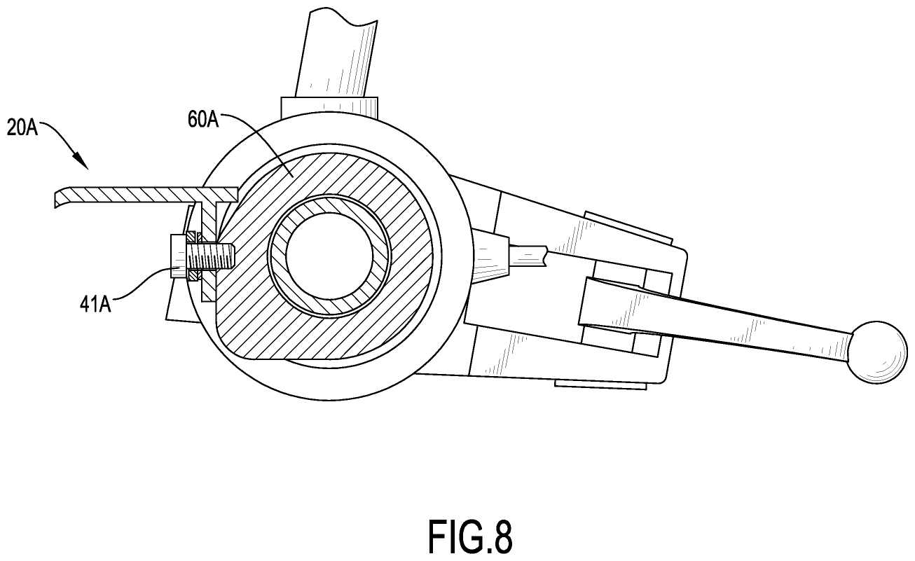

With reference to FIGS. 7 and 8, a motorcycle handle grip assembly in accordance with one or more embodiments of the present disclosure is similar to the above-mentioned motorcycle handle grip assistance device, and the difference is that the motorcycle handle grip assembly has no grip fixing element, and the hand press panel 20A is pivotally connected to the motorcycle handle grip 60A directly. Therefore, the hand press panel 20A is altered to be pivotable, relative to the motorcycle handle grip 60A, into the in-use condition and the folded condition. The components, which are mounted on the grip fixing element in the throttle assistance device, such as the limiting element and the pivot screw 41A, are altered to be mounted on the motorcycle handle grip 60A directly. Except for the above-mentioned, the motorcycle handle grip assembly is substantially the same as the motorcycle handle grip assistance device, and thus details thereof are not repeated.

Normally, the hand press panel 20 is pivoted to the in-use condition, and thus the hand press panel 20 can be pressed by the outer side of the palm of the rider, thereby facilitating rotating the motorcycle handle grip 60. When the hand press panel 20 is temporarily not in use, the rider only needs to push to pivot the hand press panel 20 toward the outer end 62 of the motorcycle handle grip 60 (thus placing the hand press panel 20 in the folded condition), and then the hand press panel 20 will become upright or substantially upright, thereby preventing the hand press panel 20 from occupying too much holding space on the motorcycle handle grip 60. Thus, the throttle assistance device not only facilitates ease in use, but also ensures riding safety.

Even though numerous characteristics and advantages of the present disclosure have been set forth in the foregoing description, together with details of the structure and features of the present disclosure, the present disclosure is illustrative only. Changes may be made in the details, especially in matters of shape, size, and arrangement of parts within the principles of the present disclosure to the full extent indicated by the broad general meaning of the terms in which the appended claims are expressed.

1. A throttle assistance device for a motorcycle handle grip, the motorcycle handle grip rotatably mounted around a handlebar and having an inner end and an outer end, and the throttle assistance device comprising:
a grip fixing element adapted to be mounted securely on the motorcycle handle grip; and
a hand press panel pivotally connected to the grip fixing element and a pivoting axis between the hand press panel and the grip fixing element being perpendicular to a rotating axis between the motorcycle handle grip and the handlebar; the hand press panel being pivotable relative to the grip fixing element into an in-use condition and a folded condition;
wherein when the hand press panel is in the in-use condition, a normal of the hand press panel is perpendicular to the rotating axis between the motorcycle handle grip and the handlebar, and the hand press panel is pivotable toward the outer end of the motorcycle handle grip to transfer the hand press panel into the folded condition; and
wherein when the hand press panel is in the folded condition, the normal of the hand press panel is parallel with the rotating axis between the motorcycle handle grip and the handlebar.

2. (canceled)

3. (canceled)

4. (canceled)

5. The throttle assistance device as claimed in claim 1, further comprising:
a limiting element mounted on the grip fixing element, and the limiting element selectively abutting the hand press panel; wherein when the hand press panel is in the folded condition, the hand press panel abuts the limiting element.

6. The throttle assistance device as claimed in claim 5, further comprising:
a connecting element, wherein an end of the connecting element is connected to an inner side surface of the hand press panel; and
a pivot screw mounted through the connecting element and screwed in the grip fixing element, thereby allowing the connecting element and the hand press panel to pivot relative to the grip fixing element.

7. The throttle assistance device as claimed in claim 6, wherein the grip fixing element comprises:
a surrounding frame adapted to surround and abut the motorcycle handle grip, and the surrounding frame has a gap formed therethrough to cut and divide the surrounding frame to form two ends on the surrounding frame; and
a fixing screw mounted through one of the two ends of the surrounding frame, and screwed in the other end of the surrounding frame, thereby making the surrounding frame tightly surround and abut the motorcycle handle grip.

8. The throttle assistance device as claimed in claim 1, wherein the grip fixing element comprises:
a surrounding frame adapted to surround and abut the motorcycle handle grip, and the surrounding frame has a gap formed therethrough to cut and divide the surrounding frame to form two ends on the surrounding frame; and
a fixing screw mounted through one of the two ends of the surrounding frame, and screwed in the other end of the surrounding frame, thereby making the surrounding frame tightly surround and abut the motorcycle handle grip.

9. The throttle assistance device as claimed in claim 1, further comprising:
a connecting element, wherein an end of the connecting element is connected to an inner side surface of the hand press panel; and
a pivot screw mounted through the connecting element and screwed in the grip fixing element, thereby allowing the connecting element and the hand press panel to pivot relative to the grip fixing element.

10. A motorcycle handle grip assembly adapted to be mounted around a handlebar of a motorcycle, the motorcycle handle grip comprising:
a motorcycle handle grip rotatably mounted around the handlebar, and having an inner end and an outer end; and
a hand press panel pivotally connected to the motorcycle handle grip and a pivoting axis between the hand press panel and the motorcycle handle grip being perpendicular to a rotating axis between the motorcycle handle grip and the handlebar; the hand press panel being pivotable relative to the motorcycle handle grip into an in-use condition and a folded condition;
wherein when the hand press panel is in the in-use condition, a normal of the hand press panel is perpendicular to the rotating axis between the motorcycle handle grip and the handlebar, and the hand press panel is pivotable toward the outer end of the motorcycle handle grip to transfer the hand press panel into the folded condition, and
wherein when the hand press panel is in the folded condition, the normal of the hand press panel is parallel with the rotating axis between the motorcycle handle grip and the handlebar.

11. (canceled)

12. (canceled)

13. (canceled)

14. The motorcycle handle grip assembly as claimed in claim 10, further comprising:
a limiting element mounted on the motorcycle handle grip, and the limiting element selectively abutting the hand press panel; wherein when the hand press panel is in the folded condition, the hand press panel abuts the limiting element.
